(19) United States
(12) Patent Application Publication
(10) Pub. No.: US 2009/0261946 A1
(43) Pub. Date: Oct. 22, 2009

(54) Access Control System for a Vehicle

(76) Inventor: Bernard Tenconi, Tuttlingen (DE)

Correspondence Address: CONTINENTAL TEVES, INC., ONE CONTINENTAL DRIVE, AUBURN HILLLS, MI, 48326-1581, US

(21) Appl. No.: 11/988,425

(22) PCT Filed: May 18, 2006
(86) PCT No.: PCT/DE2006/000865

§ 371 Date: Jan. 7, 2008

(30) Foreign Application Priority Data
Jul. 8, 2005 (DE) 10 2005 032 379.0

(51) Int. Cl. G05B 19/00

(52) U.S. Cl. 340/5.72

(57) ABSTRACT

Disclosed is an access control device for a vehicle, comprising at least one transmission unit arranged in the vehicle and at least one receiver, controlled by at least one microcomputer unit. The receiver serves to receive UHF signals and the transmission unit serves to send low-frequency long-wave signals. Also, a clamping unit is present which is triggered by the microcomputer unit and the clamping unit gives access to the vehicle when a matching code is present.

The transmission unit has two connected LC band pass filters, whereby the first band pass is a pre-filter comprises a first coil and a first condenser group comprising at least one condenser and the second band pass comprises the LF antenna as inductor and a second condenser group comprising at least one condenser. A multiplexer, via which the antennae are connected successively in multiplex mode to the transmission unit, is preferably provided between the first and second band pass.

### BACKGROUND OF THE INVENTION

The invention relates to an access control system for a vehicle having at least one transmission unit (4) arranged in the vehicle for sending low-frequency long-wave signals and a plurality of assigned LF antennae (13), arranged in the vehicle at exposed points.

DE 102 36 305 A1 discloses a generic access control system for a vehicle. It has at least one transmission unit arranged in the vehicle for sending low-frequency long-wave signals and a plurality of associated LF antennae, arranged in the vehicle at exposed points. Also, two or more user-side mobile ID transmitters are provided, at least one vehicle-side transmission/receiver for the vehicle exterior and at least one transmission/receiver for the vehicle interior for conducting wireless authentication communications with the ID transmitters, whereby one or more security devices are unlocked or locked on successful authentication of an ID transmitter.

DE 100 13 542 A1 discloses another generic arrangement for an access security system for a vehicle. This system is particularly suited for making secure access systems based on chip cards in the field of building security, though it can also be used in vehicles. The invention is distinguished in that signals, by which unambiguous identification can be undertaken, are obtained via the relative orienting or respectively positioning between a data carrier and a base station, preferably arranged in a vehicle.

The aim of the present invention is to provide an access control system for a vehicle, which can be used in particular with respect to the electromagnetic tolerance and assigning and localising of the access unit.

### SUMMARY OF THE INVENTION

This task is solved by an access control device having a transmission unit (4) has two connected LC band pass filters, whereby the first band pass as pre-filter consists of a first coil (L1) and a first condenser group comprising at least one condenser (C1 VK, C2 VK, C3 VK, . . . ) and the second band pass consists of the LF antenna (Lant) as inductor and a second condenser group comprising at least one condenser (C2, C Ant 01, C Ant 02, . . . ) Advantageous embodiments of the invention will emerge from the following description of the figures.

For this, the transmission unit has two connected LC-band pass filters, whereby the first band pass as pre-filter comprising a first coil and a first condenser group includes at least one condenser and the second band pass comprising the LF antenna as inductor and a second condenser group includes at least one condenser. This connected band pass structure enables a clear reduction in harmonics and thus a clear improvement in electromagnetic tolerance even in the event of rectangular or trapezoid excitement, as was not common in access control devices to date.

The first band pass preferably has a coil common to all antennae, by which the costs for the pre-filter itself are limited in a larger number of antennae to be operated separately. For each antenna its own condenser is provided in the pre-filter stage.

In a preferred further development a multiplexer is provided, by which the antennae are connected in succession in the multiplex mode to the transmission unit, whereby the multiplexer is arranged between the first and second band pass. Only via the two band pass filters in succession is it possible to interpose a multiplexer and in the process already transmit a substantially harmonic-free signal on the line to the antennae.

The multiplexer is preferably a shunt multiplexer, in which a switching node is switched to earth potential between first and second band pass for the respectively inactive antennae via an adjustable transistor, while this switching node for the active antenna is not switched to earth potential and thus the signal travels from the transmission unit via the first band pass to the active antenna.

Switching the switching node of the inactive antennae to earth potential preferably switches the condensers of these inactive antennae in parallel to the condenser of the active antenna in terms of alternating current and this interconnecting of condensers consequently forms the first condenser group.

The access control system generally also has an access unit, which is preferably in a key or in an access authorisation identification unit.

The control device arranged in the vehicle is preferably fitted with at least one transmitter with a low send frequency, hereinbelow designated by LF transmitter, which preferably works in the 125 kHz range, a control unit and at least one UHF receiver.

The access unit comprises a microcomputer unit, at least one LF receiver corresponding to the LF transmitter in the vehicle and at least one UHF transmitter, in turn corresponding to the UHF receiver in the vehicle.

The control device arranged in the vehicle is configured as a control unit, whereby the control unit accesses the LF transmitter, whereof the individual assigned antennae are preferably integrated into the door grips of the vehicle. Also, at least one antenna is arranged in the interior of the vehicle and also in the rear and front bumper. It has proven particularly advantageous to arrange the antennae of the LF transmitter at seven points on the vehicle at an exposed site in each case.

The access unit, which is configured in particular as a mobile identification unit, comprises at least one LF receiver, a microcomputer unit and at least one UHF transmitter, which is configured in particular as a UHF transmitter module.

The system preferably works as follows: as soon as the user actuates the door handle or another part of the vehicle, an alarm signal is first sent to the access unit via the LF transmitter. The wakeup signal is necessary, since the access unit is in the rest state, so-called sleep mode, when not in use, to keep power consumption to the access unit as low as possible. The alarm signal, received by the LF receiver of the access unit, now wakes up the latter and sends its own specific identification code via the UHF transmitter.

If this code does not match the code lodged in the control device of the vehicle, the door of the vehicle stays locked. But if the identification code is recognised the lock of the vehicle, or respectively the door lock of the vehicle, is unlocked, and the user can open the vehicle.

The control device, which controls the LF transmitter, is connected, as already indicated, preferably to the microcomputer unit, which in turn cooperates with a driver circuit for operating the transmitter antennae for low-frequency signals, adapted for the LF transmitter. At the same time however the microcomputer unit also controls the UHF receiver, since once the UHF signal is received and authentication is received, unlocking of at least one access opening to the vehicle takes place.

The microcomputer unit and the driver circuit for the LF transmitter and the LF antennae generate a transmission signal, which comprises a high-frequency carrier in the long wave range with a nominal frequency of 125 kHz. The high-frequency carrier is amplitude-modulated. The resulting AM signal contains a bit rate transfer for sending the alarm signal to the access unit. With ideal transfer a square wave signal is modulated to the amplitude of the high-frequency carrier. Transferring such a signal via long wave requires diverse measures, in particular with respect to the frequency spectrum, since side bands and harmonics of the carrier may not exceed certain preset values due to radio approval of the radio identification.

The LF transmitter also cooperates with a pulse-width modulator, a driver, a pre-filter, at least one LF transmission antenna and a rectifier and regulator filter circuit located in the feedback region. It has proven advantageous to effectively use an antenna current of 1.41 A in a range of 1.5 m of the LF signal around the antenna(e). To achieve this current independently of the battery voltage of the vehicle and other interference factors from now on the modulation signal delivered by the microcomputer unit via the pulse-width modulator changes in the pulse-width ranges such that the antenna oscillating circuit is supplied or respectively nudged by a booster circuit with just as much power for the abovementioned required antenna current to flow. The power supply increases via a wide pulse cycle and the current rises; with a narrow pulse the power supply diminishes and the current drops. If the nominal current value is reached then just that much more power must be fed to the antenna for the nominal current to stay as is. The pulse-width modulated signal is stored in the antenna via a booster circuit and a double Pi band pass filter acting as transmitter. The current is ascertained by the band pass filter via a peak equaliser. The voltage obtained is proportional to the transmission antenna current. In order to guarantee continuous antenna current from here on the supplied pulse width modulation width of the signal is adapted incrementally via the microcomputer unit. Incremental adaptation occurs in a ratio of 1 to N, whereby N is the number of the ongoing modulation spikes. It has proved to be advantageous to leave at least four pulses unchanged in each case. As soon as a preferred current flow is set in the antenna with feedback and back measurement, the incremental adjusting by the microcomputer unit fixes on the desired value.

To generate a transmission signal without interfering harmonics the pre-filter is used for the transmission antenna(e). This pre-filter is configured as a dual-circuit pre-filter and succeeds in already attenuated the third harmonic in the first cycle by 45 dB. This is how the connection from the control device to the transmission antenna is not impacted with unnecessary harmonics. The second transmission circuit comprises an inductor and a capacitor. This series resonance circuit is synchronised to the resonance frequency of 125 kHz, the send frequency itself.

### BRIEF DESCRIPTION OF THE DRAWINGS

The invention will now be explained in greater detail by means of embodiments and figures, in which:

FIG. 1 shows a schematic design of the essential elements of the access control systems;

FIG. 2 shows a schematic design of the control device of the access control systems;

FIG. 3 shows a further schematic design of the control device;

FIG. 4 is a schematic illustration of the operation of the pulse-width modulation regulation; and

FIG. 5 shows a further schematic design of the control device with integration of a digital module;

FIG. 6 shows a further schematic design of the control device with integration of a digital module;

FIG. 7 shows a further simplified schematic design of the control device with integration of a digital module;

FIG. 8 shows the operation of the connected band pass filter and the shunt multiplexer.

### DETAILED DESCRIPTION OF THE DRAWINGS

In the figures the same reference numerals are used for identical components or respectively groups in all figures. This makes for easier understanding of the description.

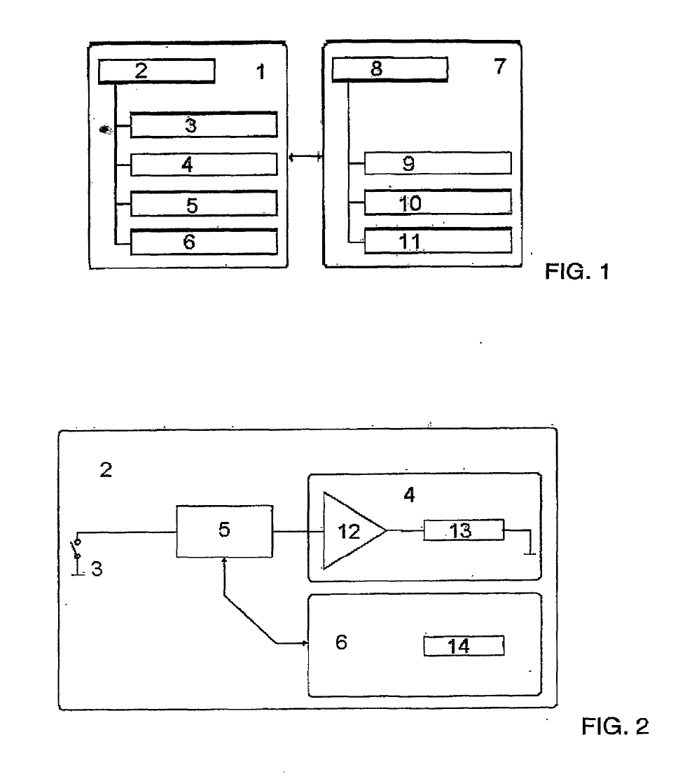

The access control system illustrated in FIG. 1 comprises the two essential units 1, 7, whereby the first unit 1 is arranged or respectively integrated in the vehicle and the second unit 7, the access unit, is arranged or respectively integrated preferably in a key or in an access authorisation identification unit for the vehicle.

The unit 1 arranged in the vehicle preferably is a control device 2, which is fitted with at least one LF transmitter 4 with a low send frequency, a so-called LF transmitter, which preferably works in the 125 kHz range, a microcomputer unit 5, and at least one UHF receiver 6. An LF transmitter 4 is in each case arranged preferably in each of the door grips 3 of the vehicle or respectively on the latter.

The access unit 7 for its part comprises a microcomputer unit 10, at least one LF receiver 9 corresponding to the LF transmitter 4 in the vehicle and at least one UHF transmitter 11, which in turn corresponds to the UHF receiver 6 in the vehicle, as well as a unit 8, not requiring further explanation at this point, which serves for example to code the transmission signals. The LF receiver 9 is optimised to the transmission characteristic of the LF transmitter 4 and UHF receiver 6 to the transmission characteristic of the UHF transmitter 11.

The access unit 7 naturally contains a power supply unit which supplies the units and electrical components with the required power. This power supply unit is charged every time the vehicle starts up via its on-board power supply, for example via the unit 8.

The unit 1 also has at least one more LF antenna assigned to it in the interior of the vehicle and in the rear and front bumper of the vehicle. It has proven particularly advantageous to position the antennae 4 at seven points on the vehicle in an exposed location in each case.

If the user actuates one of the door grips 3 or another part of the vehicle first an alarm signal is sent to the access unit 7 via all LF transmitters 4, activated in succession. The wakeup signal is necessary, since the access unit 7 is in the rest state, so-called sleep mode, when not in use, to keep power consumption to the access unit 7 as low as possible. The alarm signal, received by the LF receiver 9 of the access unit 7, now wakes up the microcomputer unit 10 in the access unit 7, which in turn sends the specific identification code to the control device 2 via the UHF transmitter 11. If this code does not match the code lodged in the control device 2 of the vehicle, the door of the vehicle stays locked. But if the identification code is recognised the lock of the vehicle, or respectively the door lock of the vehicle, is unlocked, and the user can open the vehicle.

The operating principle of the control unit 2 is described in greater detail by way of FIG. 2. The control unit 2, which triggers the LF transmitter 4 via the microcomputer unit 5, has a driver circuit 12 for running the LF transmission antennae 13, with only one antenna shown in FIG. 2 for clarity, for low-frequency signals, adapted for the LF transmitter 4. The other LF transmission antennae 13 are connected in parallel to the transmission antenna illustrated in FIG. 2 and are triggered in succession by a multiplexer. At the same time, however, the microcomputer unit 5 also controls the UHF receiver 6, since only after the UHF signal and authentication are received is at least one access opening to the vehicle unlocked. The UHF receiver 6 in turn has a UHF receiving antenna 14 for receiving UHF signals.

The microcomputer unit 5 and the driver circuit 12 for the LF transmitter 4 and the LF antennae 13 generate a transmission signal, comprising a high-frequency carrier in the long wave range with 125 kHz nominal frequency. The high-frequency carrier is amplitude-modulated. The resulting AM signal contains a bit rate transfer for sending the alarm signal to the access unit 7. With ideal transfer a square wave signal is modulated to the amplitude of the high-frequency carrier. Transferring such a signal via long wave requires diverse measures, in particular with respect to the frequency spectrum, since side bands and harmonics of the carrier may not exceed certain preset values due to radio approval of the radio identification.

The LF transmitter 4 also cooperates with a pulse-width modulator, a driver, a pre-filter, at least one LF transmission antenna and a rectifier and regulator filter circuit located in the feedback region.

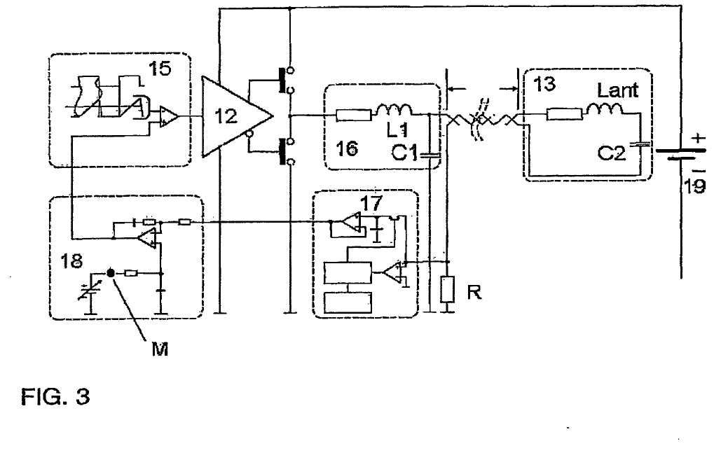

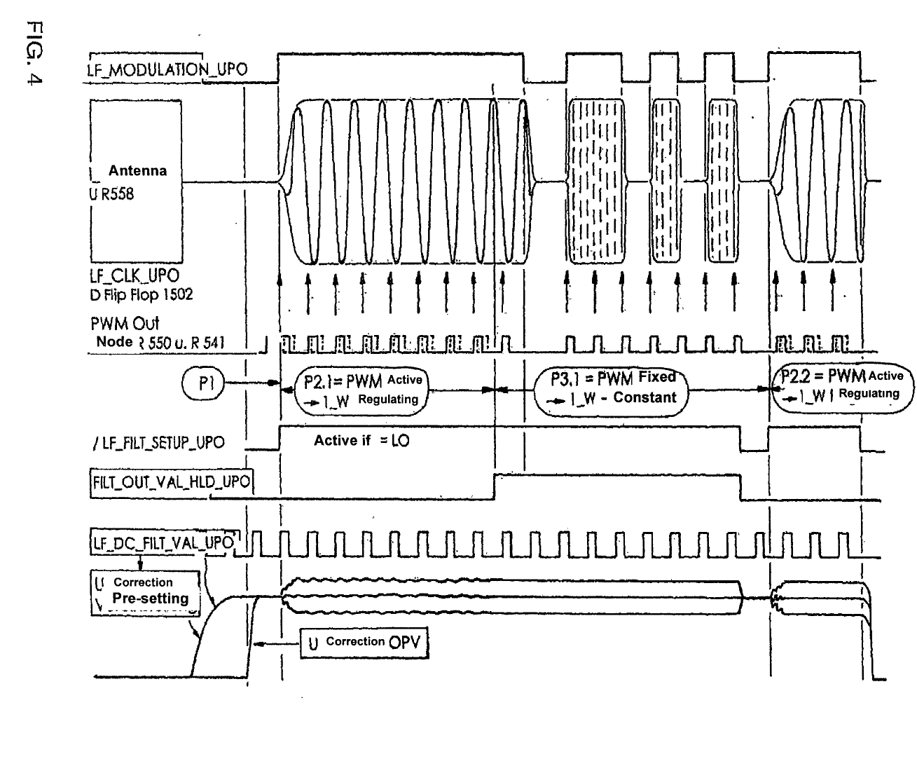

In FIG. 3 this is illustrated in greater detail. It has proven advantageous to effectively use an antenna current of 1.41 A in a range of 1.5 m of the LF signal around the antenna(e) 13. To achieve this current independently of the power supply 19, the battery voltage of the vehicle and other interference factors the modulation signal delivered by the microcomputer unit 5 via the pulse-width modulator 15 is changed in the pulse-width ranges such that the antenna oscillating circuit 13 is supplied or respectively nudged by a booster circuit with just as much power for the abovementioned required antenna current to flow. The power supply increases via a wide pulse cycle and the current rises; with a narrow pulse the power supply diminishes and the current drops. If the nominal current value is reached then just that much more power must be fed to the antenna 13 for the nominal current to stay as is. The pulse-width modulated signal is stored in the LF antenna 13 via a booster circuit 12 and a double Piband pass filter (L1, C1, Lant, C2) acting as transmitter. The current is ascertained by the band pass filter via a peak equaliser 17. The voltage obtained is proportional to the transmission antenna current. In order to guarantee continuous antenna current from here on the supplied pulse width modulation width of the signal is adapted incrementally via the microcomputer unit 5. Incremental adaptation occurs in a ratio of 1 to N, whereby N is the number of the ongoing modulation spikes. It has proved to be advantageous to leave at least four pulses unchanged in each case. As soon as a preferred current flow is set in the antenna with feedback and back measurement, the incremental adjusting by the microcomputer unit 5 fixes on the desired value.

The LF transmission antenna 13 is configured as a long wave antenna. The whole transmitter mechanism includes a booster device in the form of a central booster, whereof the operating voltage is supplied from the power supply 19.

The LF transmission antenna 13 is attached directly to the output of the booster. The LF transmission antennae 13 are activated separately by a multiplexer device or respectively a multiplexer, not shown in FIG. 3, and then switched on in a specific sequence and time sequence and thus activated in succession.

Connected in the earth branch of the multiplexer not shown in FIG. 2 is a resistor, in particular a shunt, for measuring current, which is part of a current control. The current control includes a current detector in the form of an excess current comparator which measures the transmission current sent via the LF transmission antennae 13 and the multiplexer.

When the unit 1 is operating, the driver 12 triggered on the input side by a low-frequency trigger signal on the output side generates a square wave voltage, which acts to jointly trigger the LF transmission antennae 13 directly via the booster output. At the same time the LF transmission antennae 13 are switched on in a presettable time sequence successively to the driver 12 by means of the multiplexer, thus creating particularly low-loss triggering. The driver 12 is advantageously designed as a counter-clock stage.

The transmission current guided via the LF transmission antenna 13 activated in each case is measured as described. The excess current comparator compares the transmission current to a preset reference value. When the reference value is exceeded current limiting of the transmission current takes place by means of a current control on the presettable reference value constituting the nominal value of the current control. For this, the excess current comparator generates on the output side a control or trigger signal fed to the input of the driver 12 for controlling the output of the final stage. The actual value of the transmission current is synchronised with the nominal value.

Each LF transmission antenna 13 is designed as a transmission coil Lant, which is synchronised to the series resonance by means of a condenser C2 connected thereto in series.

For easy and economical triggering the pulse width modulation trigger signal is sent by the pulse width modulator 15 to the driver 12. The pre-filter 16 is used to produce a transmission signal without interfering harmonics. This dual-cycle filter can be used to already attenuate the third harmonic in the first cycle by up to 45 dB.

The result from the first cycle and the second cycle is a dual-Piband pass filter (comprising a pre-cycle 1 with L1, C1 and a second filter cycle 2 of LAnt, C2).

An alternating voltage is produced at the input of the rectifier 17 over the series resistor R. This is an image of the current flowing via the LF transmission antenna 13. This voltage is rectified via a rectifier 17. The equalised voltage is applied to the output of the rectifier 17 and acts as input signal of the regulation filter 18.

A time-basis generator generates a periodic 125-kHz square wave digital signal. A ramp is made by this signal in turn via the positive flank and transmitted to the inverted input of a comparator. The non-inverted input of this comparator receives from the regulating filter 18 Voltage dependent on the amplitude of the antenna current.

The nominal value of the antenna current or respectively the field strength is preset by the measuring point M. An operating booster acts as regulating filter. Assuming that the antenna current rises, the alternating voltage will rise at the input of the rectifier 17. And the DC voltage also grows proportionally at the output of the rectifier 17. The inverted input of the operating booster in the regulating filter 18 thereby receives more positive voltage than the nominal voltage value at the measuring point M to be seen at the non-inverted input. This difference in voltage is integrated. The output voltage of the regulating filter 18 accordingly drops. The output voltage of the regulating filter 18 is supplied to the pulse width modulator 15. The positive pulse becomes narrower, since the power at the dual-Pi-band pass filter has lessened. The result is that the voltage at the input of the rectifier 17 has also lessened. The difference between actual value and nominal value is narrowed, so that the correct value is adjusted.

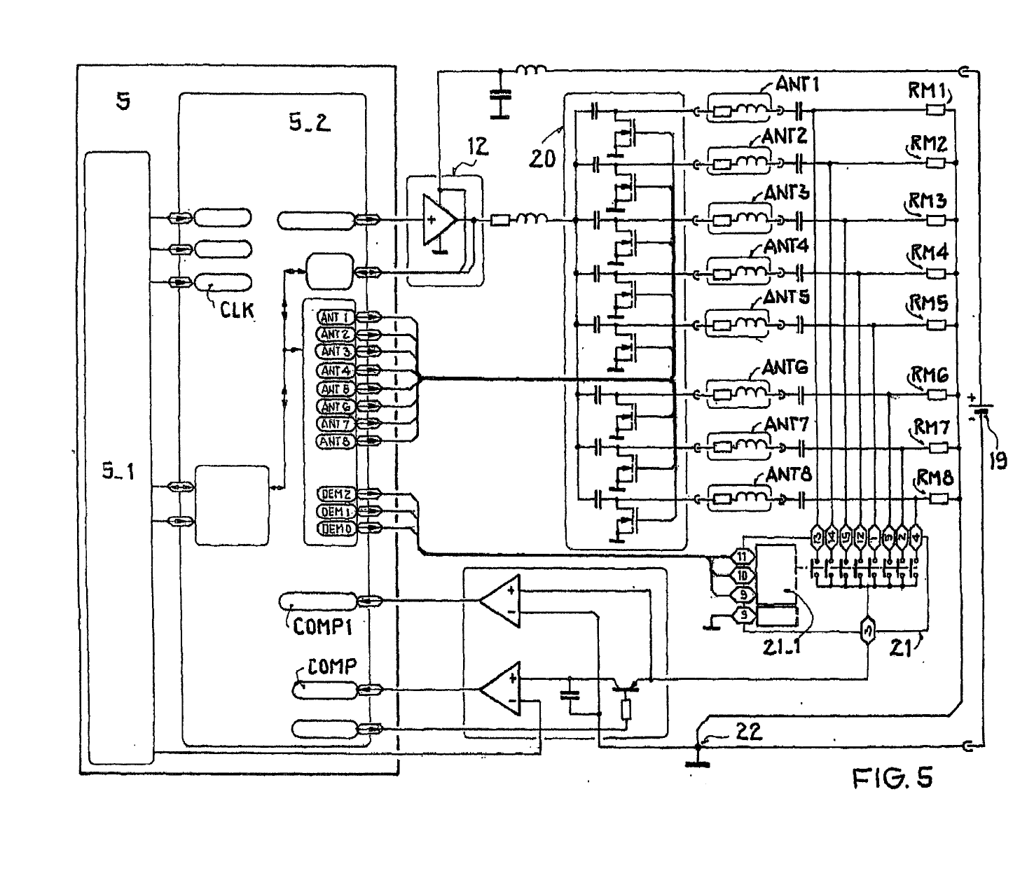

The regulating sequence is described in greater detail by means of the flow diagram of FIG. 4.

So that on restart or an undefined operating status for example the actual value U_korrektur is adjusted as quickly as possible to the reference variable after a certain transmission time, during phase P1 the integration filter is preset to a rough value U0. This occurs by means of the signal LF DC FILT_VAL_UPO (cf. FIG. 3) until LF_FILT_SETUP_UPO=LOW.

For leaving presetting and activating the PWM after release by the signal LF_MODULATION_UPO and LF_FILT_SETUP_UPO=HIGH is switched through (FILT_OUT_VAL_HLD_UPO=LOW) i.e. the regulating performance in phase P2 becomes active, as above.

In phase P2.1 the carrier signal is therefore sent unmodulated (PWM out) and the current is detected by the antenna (I_Antenne) and re-adjusted, as is evident from the fluctuations in U_Korrektur.

In the subsequent transmission phase P3.1 signal FILT_OUT_VAL_HLD_UPO=HIGH and thus the PWM ratio is fixed until the data transfer cycle is completed.

From this point onwards data bits can be transmitted over 100% modulation of the carrier. Since switching the carrier on or respectively off is far above a time constant of the carrier, the previous measures and a correspondingly measured period of a data transfer cycle prevent beats of U_Korrektur and thus the carrier amplitude takes place.

Following the preset period P3 of a data transfer cycle the cycle again becomes active.

So as to run the transmission circuit over a wide range of operating voltages at low loss, a PWM signal generator for generating a pulse width-modulated signal of preset clock frequency is provided, whereby the clock frequency of the PWM (base) signal grows, and is preferably a multiple of the frequency of the digital signal. To transfer the digital signal it is superposed on the PWM signal, i.e. correspondingly low-frequency amplitude modulation to the PWM base signal takes place. The PWM signal controls semiconductor switches in the switch operation, whereby the transmission antenna is connected upstream of the band pass pre-filter.

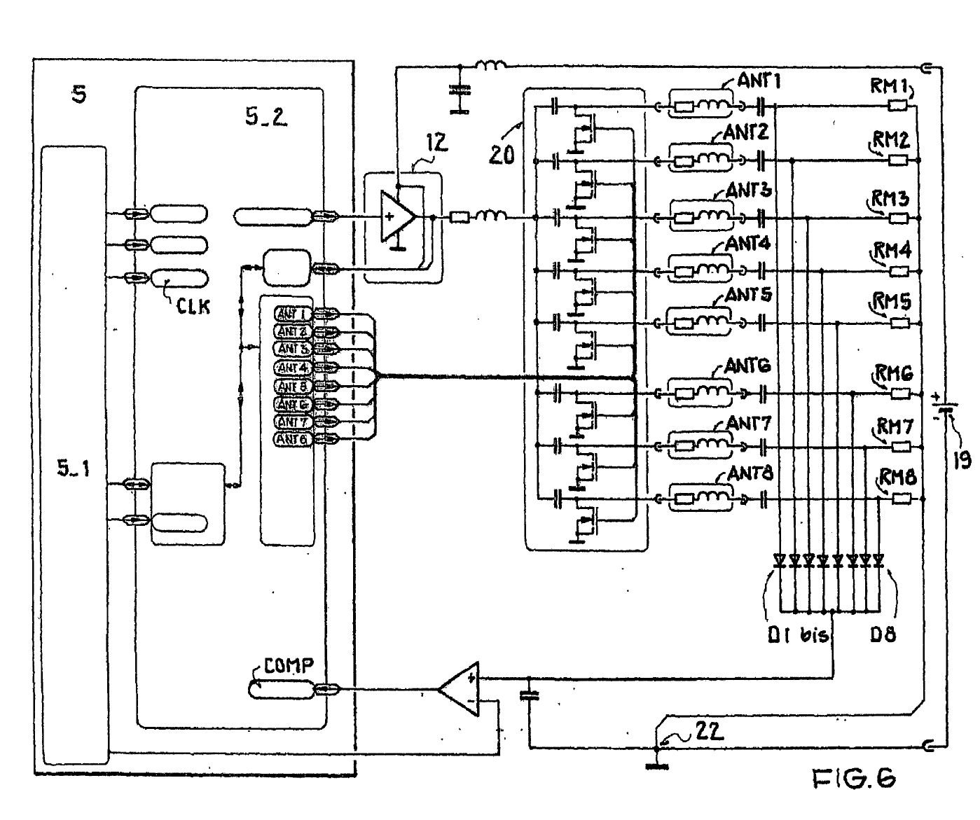

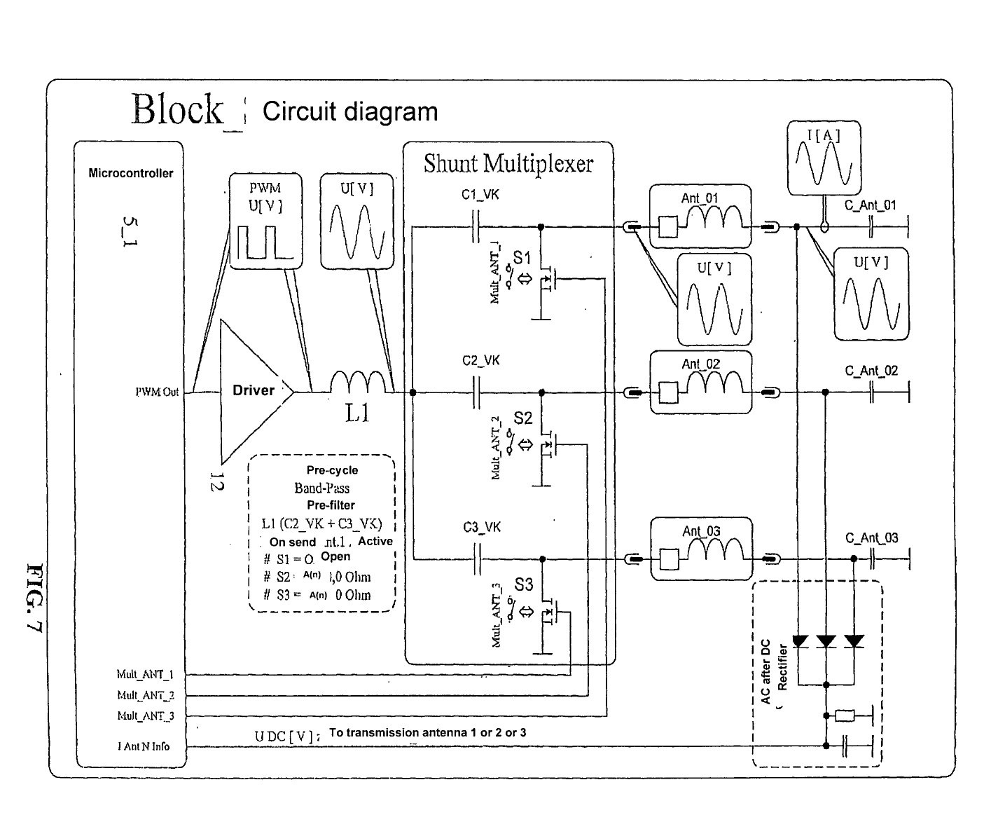

FIGS. 5 and 6 illustrate another embodiment, in which a majority of the elements of the invention, in particular unit 1, has been substituted by digital regulating and an electronic digital module. The microcomputer unit 5, comprising a computer unit 5_1 and the associated peripheral 5_2 takes over the regulating digitally.

The LF transmitter is shown with 8 transmission antennae Ant1 to Ant8. Triggering the pulse width modulation is done directly by the microcomputer unit 5 via one of its QPWM output ports. The pulse width modulation can either be regulated digitally via the QPWM output ports. The pulse width modulation can either be regulated digitally via the microcomputer unit 5, or, with knowledge of the parameters, can be calculated directly and set directly. A clock signal is output via the CLK output port, which provides the time interval for the entire peripheral wiring.

In FIG. 5 the antenna current of each of the LF transmission antennae Ant1 to Ant8 is fed via a demultiplexer 21 to a line and compared via a comparator to the nominal antenna current. The outcome of the comparison is fed via the COMP input port of the microcomputer unit 5. The multiplexer 20 and the demultiplexer 21 are controlled in parallel by the microcomputer unit 5. A binary to 1-8 decoder 21_1 is provided.

In FIG. 6 the demultiplexer is replaced cost-effectively in each case by a diode D1 to D8.

Digital adjusting occurs via the input values at the COMP input port, where the comparative value is between actual antenna current and the preset nominal value. Depending on this outcome the microcomputer unit 5 triggers the driver 12 and thus the pulse width via the QPWM output port.

The already described regulating can also be circumvented by the respective values being calculated in advance.

This can be calculated by means of the following equations:

The effective value of the current of the LF transmission antenna 13 can be calculated as follows:

$$I\_Ant \_eff := [ sin [ ( \frac{π}{2} ) \cdot ( \frac{PWM\_nS}{4000} ) ] ] \cdot ( \frac{1}{\sqrt{8}} ) \cdot Linear\_Fakt \cdot U\_Batt$$

whereby PWM_nS is the value of the period of the pulse width in nsec,
Linear_Fakt is the product of the square of the antenna current with the electrical resistance of the antenna, and
U_Batt is the supply voltage.

If, on the other hand, the effective value of the antenna current is known, or respectively is it is to be set, the pulse width in nsec is calculated as follows:

$$PWM\_nS := [ a sin [ \frac{I\_Ant \_eff \cdot ( \sqrt{8} )}{( Linear\_Fakt \cdot U\_Batt )} ] ] \cdot [ \frac{1}{( π \cdot 0.5 )} ] \cdot 4000$$

The desired value can thus be calculated digitally and adjusted directly.

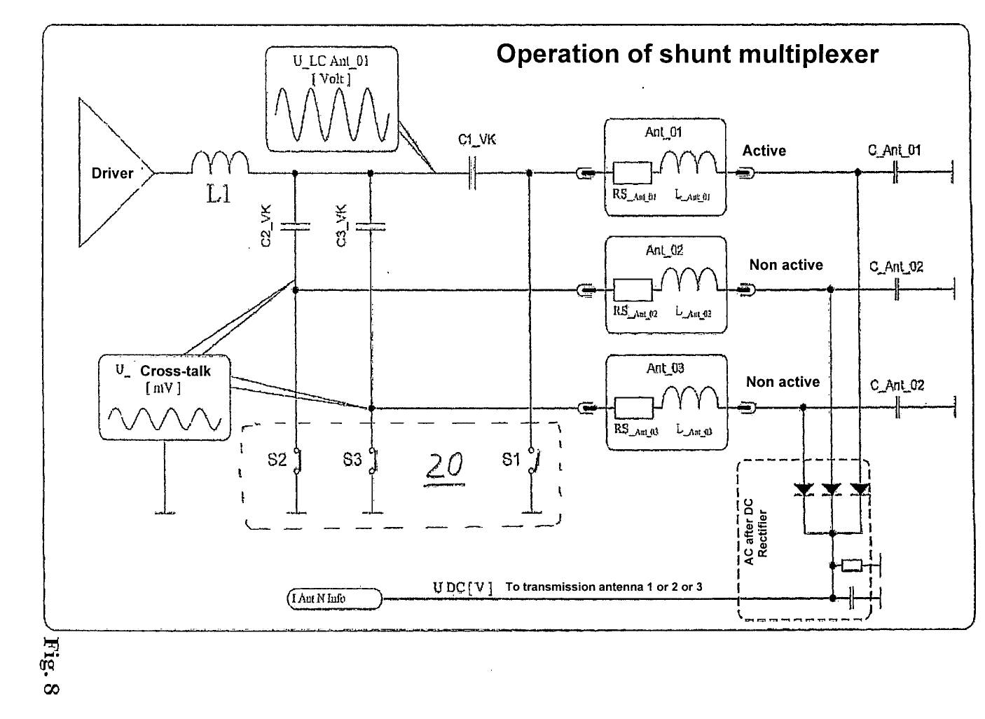

In FIG. 7, the structure of the invention is illustrated by an embodiment with three antennae. The microcontroller 5_1 emits the corresponding signal to the antennae Ant 01 to Ant_03, whereby the signals are conveyed via the driver 12 to the multiplexer 20, configured as a shunt multiplexer. The DC voltage can be obtained particularly easily using this arrangement and wiring and design according to FIG. 7. This voltage represents an image of the current in the antennae or respectively antenna and thus enables ideal triggering of the antenna and optimising of the antenna current. The configuration in FIG. 7 can advantageously allow the resonance condensers C_Ant_01 to C_Ant 03 and the condensers C1_VK to C3_VK to be arranged on a platen, with only the antennae to be arranged in an exposed position. This also enables the voltage U DC, which is a copy of the antenna current, to be obtained.

There is no complicated electronic configuration necessary by the configuration in FIG. 7 to obtain the voltage U DC. If now the condensers C1_VK and C_Ant_01 are selected such that they are identical, then this results in phase angle rotation of 180° for the voltage on these condensers. The advantage is that harmonics are avoided.

The particularly preferred configuration of the transmission unit comprising two connected LC band pass filters and the interposed shunt multiplexer 20 will again be explained in greater detail by way of FIG. 8.

The first band pass forms the pre-filter from the first coil L1 and first condenser group. Ant_01 is active and the other two antennae Ant_02 and Ant 03 are inactive.

Since the multiplexer 20 is configured as a shunt multiplexer, in each case the switching node between first and second band pass is switched to earth potential for the respectively inactive antennae Ant_02 and Ant_03 via an adjustable transistor. CMOS-semiconductors are preferably used here as a transistor, which enable very rapid toggling of the transmission antennae, in particular switchover times of less than 400 μS. Compared to mechanical relays there is an additional advantage in the virtually unlimited service life and reliability of multiplexer systems, since only semiconductors are used.

By switching the respective switching node of the inactive antennae Ant_02, Ant_03 to earth potential by means of switches S2, S3 the condensers C2_VK, C3_VK of these inactive antennae are switched in parallel to the condenser C1_VK of the active antenna Ant_01 in terms of AC and this parallel switching of condensers C1 VK, C2 VK, C3 VK thus forms the first condenser group. The condenser C1_VK connected directly in series can therefore clearly be smaller in size, resulting in obvious cost savings in particular for systems with a larger number of separate antennae.

The second band pass comprises the LF antenna Ant_01 as inductor and a second condenser group of at least one condenser, here C Ant 01.

The first band pass is thus formed by the coil L1 and the couple condensers C2_VK, C3_VK of the currently unused antennae Ant_02, Ant_03. These condensers are earthed via the CMOS multiplexer switch.

The non-active antennae in each case comprise assigned Rs_Ant_xx, L_Ant xx and C_Ant_xx. The impedance for the inactive antennae is highlighted in equations 1b and 1c.

Impedance evaluation of the inactive antenna No. 2 description, Z_Ant_02_switched off:

$$Z\_Ant02 \_switchedoff = {\sqrt{RS\_Ant \_ {02}^{2} + [ \begin{matrix}L\_Ant \_ 02 \cdot 2 \cdot π Freq - \\ [ \frac{1}{( C\_Ant \_ 02 ) \cdot 2 \cdot π \cdot Freq} ]\end{matrix} ]}}^{2} \qquad 1 b$$

Impedance evaluation of the inactive antenna No. 3 description, Z_Ant_03_switched off:

$$Z\_Ant03 \_switchedoff = {\sqrt{RS\_Ant \_ {03}^{2} + [ \begin{matrix}L\_Ant \_ 03 \cdot 2 \cdot π Freq - \\ [ \frac{1}{( C\_Ant \_ 03 ) \cdot 2 \cdot π \cdot Freq} ]\end{matrix} ]}}^{2} \qquad 1 c$$

The second band pass is the active antenna (in FIG. 8 Ant_01). This antenna is synchronised to the send frequency, whereby the impedance is determined by RS_Ant_01, C_Ant_01 and C1_VK. The impedance calculation of this active antenna is shown under 1a.

Impedance evaluation of the inactive antenna No. 1 description, Z_Ant_01_active:

$$Z\_Ant01 \_active = {\sqrt{RS\_Ant \_ {01}^{2} + [ \begin{matrix}L\_Ant \_ 01 \cdot 2 \cdot π Freq - \\ [ \frac{1}{[ \frac{( C1\_Vk \cdot C\_Ant \_ 01 )}{( C1\_Vk + C\_Ant \_ 01 )} ] \cdot 2 \cdot π \cdot Freq} ]\end{matrix} ]}}^{2} \qquad 1 a$$

Since semiconductor multiplexers in the switched state do not display the theoretical zero Ohm, rather a few milli Ohm, a residual voltage of quite a number of mV results from the apparent current via C2_VK and C3_VK on the multiplexers. Since with both non-active antennae both tuning capacitors are switched in parallel by the multiplexer, the capacity of the tuning capacitor of these inactive antennae doubles.

Compared to the send frequency both inactive antennae are considerably untuned and thus crosstalk from increasing the series impedance in the send frequency (see equation 1b or 1c above) is prevented.

The equation for the crosstalk suppression is found under 1e.

### U_Crosstalk Suppression by Impedance Detuning of Non-Active Antenna

Complete equation if:

C1_VK=C2_VK=C3_VK and C_Ant_{—}01=C_Ant_{—}02=C_Ant_{—}03 -1e-

### U_Crosstalk Suppression:

$$U\_crosstalksuppression = \sqrt{\frac{[ RS\_Ant \_ {01}^{2} + {[ \begin{matrix}L\_Ant \_ 01 \cdot 2 \cdot π Freq - \\ [ \frac{1}{( C1\_Vk ) \cdot 2 \cdot π \cdot Freq} ]\end{matrix} ]}^{2} ]}{[ RS\_Ant \_ {01}^{2} + [ \begin{matrix}L\_Ant \_ 01 \cdot 2 \cdot π Freq - \\ [ \frac{1}{[ \frac{( C1\_Vk \cdot C\_Ant \_ 01 )}{( C1\_Vk + C\_Ant \_ 01 )} ] \cdot 2 \cdot π \cdot Freq} ]\end{matrix} ] ]}}$$

The actual crosstalk current for the inactive antennae is found under 1f and 1g.

### Evaluation Equation Current Crosstalk for the Inactive Antenna 2

### I_crosstalk_inactive_Ant_{—}02:

U_crosstalk:=30·10⁻³

### U_Crosstalk: Voltage on Switched-Through Multiplexer

$$\begin{matrix}U\_crosstalk \_inactive \_Ant \_ 02 = \frac{U\_crosstalk}{{\sqrt{RS\_Ant \_ {02}^{2} + [ \begin{matrix}L\_Ant \_ 02 \cdot 2 \cdot π Freq - \\ [ \frac{1}{( C 2 \_Vk ) \cdot 2 \cdot π \cdot Freq} ]\end{matrix} ]}}^{2}} & 1 f \\ U\_crosstalk \_inactive \_Ant \_ 03 = \frac{U\_crosstalk}{{\sqrt{RS\_Ant \_ {03}^{2} + [ \begin{matrix}L\_Ant \_ 03 \cdot 2 \cdot π Freq - \\ [ \frac{1}{( C 3 \_Vk ) \cdot 2 \cdot π \cdot Freq} ]\end{matrix} ]}}^{2}} & 1 g\end{matrix}$$

Practical measurements have proven that crosstalk in a magnitude of less than 0.05% is (−66 dB), i.e. a transmission current in the active antenna of 2000 mA, produces a crosstalk current of less than 1 mA in the non-active antennae.

The calculation principle remains the same for changing the active antenna to Ant_02 or Ant_03.

### LEGEND

1 unit
2 control device
3 door grip(s)
4 LF transmitter
5 microcomputer unit
6 UHF receiver
7 access unit
8 unit
9 LF receiver
10 microcomputer unit
11 UHF transmitter
12 driver
13 LF transmission antenna
14 UHF receiving antenna
15 pulse width modulator
16 pre-filter
17 rectifier
18 regulating filter
19 power supply
20 multiplexer
21 demultiplexer
22 earth (reference)
5_1 computer unit
5_2 peripheral
21_1 Bin to 1 of 8 decoder
RM1 to RM8 resistor
D1 to D8 diode
Ant1 to Ant 8 LF transmission antennae
Ant_01 to Ant_03 LF transmission antennae
C1_VK to C3_VK condensers
C_Ant_01 to C_Ant_03 condensers
U DC voltage
CLK clock
COMP, COMP 1 input port
OPWM output port

1-13. (canceled)

14. An access control device for a vehicle
at least one transmission unit (4) arranged in the vehicle for sending low-frequency long-wave signals; and
a plurality of assigned LF antennae (13), arranged in the vehicle at exposed points, wherein
the transmission unit (4) has two connected LC band pass filters, whereby the first band pass as pre-filter consists of a first coil (L1) and a first condenser group comprising at least one condenser (C1 VK, C2 VK, C3 VK, . . . ) and the second band pass consists of the LF antenna (Lant) as inductor and a second condenser group comprising at least one condenser (C2, C Ant 01, C Ant 02, . . . ).

15. The access control device of claim 14, wherein the first band pass has a coil (L1) common to all antennae and has its own condenser (C1 VK, C2 VK, . . . ) for each antenna.

16. The access control device of claim 14, wherein a multiplexer (20) is provided, via which the antennae (13) are connected successively in multiplexer mode to the transmission unit (4), whereby the multiplexer (20) is arranged between the first and second band pass.

17. The access control device of claim 16, wherein the multiplexer (20) is a shunt multiplexer, in which a switching node is switched to earth potential between first and second band pass for the respectively inactive antennae via an adjustable transistor, while this switching node for the active antenna is not switched to earth potential and thus the signal travels from the transmission unit via the first band pass to the active antenna.

18. The access control device of claim 17, the first band pass has a coil (L1) common to all antennae and its own condenser (C1 VK,C2 VK, C3 VK) for each antenna and through switching (S2,S3) of the switching nodes of the inactive antennae (Ant_02, Ant03) to earth potential the condensers (C2 VK, C3 VK) of these inactive antennae are switched in parallel to the condenser (C1 VK) of the active antenna (Ant 01) in terms of alternating current and this parallel switching of the condensers (C1 VK,C2 VK, C3 VK) consequently forms the first condenser group.

19. The access control device of claim 14, wherein the transmission unit (4) works with a carrier frequency of 125 kHz.

20. The access control device of claim 14, wherein the antenna current is adjusted in the antennae (13) via a pulse width modulation.

21. The access control device of claim 20, wherein a microcomputer unit (5) controls the pulse widths of a pulse width modulator (15) depending on the antenna current, by the width of the pulse widening in the event of insufficient current and the pulse narrowing whenever the antenna current exceeds a preferred value.

22. The access control device of claim 21, wherein the microcomputer unit (5) changes the pulse width incrementally.

23. The access control device of claim 21, wherein the microcomputer unit (5) determines the antenna current via a band pass filter.

24. The access control device of claim 21, wherein the microcomputer unit (5) calculates the effective value of the current in the LF transmission antenna (13) according to
$$I\_Ant \_eff := [ sin [ ( \frac{π}{2} ) \cdot ( \frac{PWM\_nS}{4000} ) ] ] \cdot ( \frac{1}{\sqrt{8}} ) \cdot Linear\_Fakt \cdot U\_Batt$$
whereby
PWMnS is the value of the period of the pulse width in nsec,
Linear_Fakt is the product of the square of the antenna current with the electrical resistance of the antenna
U_Batt is the supply voltage, and
I_Ant_eff is the effective value of the antenna current.

25. The access control device of claim 21, wherein the microcomputer unit (5) calculates the width of the pulse of the pulse width modulator (15) with knowledge of the desired effective value of the antenna current in nsec according to
$$PWM\_nS := [ a sin [ \frac{I\_Ant \_eff \cdot ( \sqrt{8} )}{( Linear\_Fakt \cdot U\_Batt )} ] ] \cdot [ \frac{1}{( π \cdot 0.5 )} ] \cdot 4000$$
whereby
PWMnS is the value of the period of the pulse width in nsec,
Linear Fakt is the product of the square of the antenna current with the electrical resistance of the antenna,
U_Batt is the supply voltage, and
I_Ant_eff is the effective value of the antenna current.

26. The access control device of claim 14, wherein in addition to at least one transmission unit (4) arranged in the vehicle at least one receiver (6) is provided, which is triggered by at least one microcomputer unit (5) and the receiver (6) is configured for receiving UHF signals and the transmission unit (4) is configured for sending low-frequency long-wave signals, and a clamping unit, which is triggered by the microcomputer unit (5), whereby a mobile unit (7) is available in which a low-frequency long wave signal receiver (9) for receiving the low-frequency long-wave signals of the transmission unit (4) arranged in the vehicle and a UHF transmitter (11) are arranged, and when an arrangement or device on the vehicle is approached and/or activated the transmission unit (4) emits an alert signal generated by the microcomputer unit (5), whereby a microcomputer unit (19) arranged in the mobile unit (7) wakes up on receiving the alert signal and the mobile unit (7) sends out an identification signal via the UHF transmitter (11), and when the identification signal matches the identification stored in the microcomputer unit (5) in the vehicle the clamping unit is released on match-up.
